(19) United States
(12) Patent Application Publication
(10) Pub. No.: US 2010/0185423 A1
(43) Pub. Date: Jul. 22, 2010

(54) METHOD FOR DESCRIBING RELATIONS IN SYSTEMS ON THE BASIS OF AN ALGEBRAIC MODEL

(76) Inventors: Henk Nico Jan Poulisse, Rijswijk (NL); Daniel Heldt, Rijswijk (NL); Sebastian Pokutta, Darmstadt (DE); Martin Kreuzer, Salzweg (DE)

Correspondence Address: SHELL OIL COMPANY, P O BOX 2463, HOUSTON, TX, 772522463, US

(21) Appl. No.: 12/373,127

(22) PCT Filed: Jul. 11, 2007
(86) PCT No.: PCT/EP07/57109

§ 371 Date: Mar. 30, 2010

(30) Foreign Application Priority Data
Jul. 11, 2006 (EP) 06116994.2

(51) Int. Cl. G06F 17/18; G06F 19/00; G06Q 10/00

(52) U.S. Cl. 703/2; 702/6; 705/348

(57) ABSTRACT

A method for describing one or more relations in a physical or other system on me oasis of an algebraic model of the system comprises the steps of: a) collecting data comprising measurements of different quantities relating to the system; b) interpreting the measurements of the different quantities as evaluations of different variables, which together comprise a polynomial ring; c) calculating an ideal of the ring, the generators of which substantially vanish on the collected data; d) interpreting the generators as polynomial relations between the variables of the system; e) reformulating at least one of the polynomial relations as an algebraic model for one of the variables in terms of the other variables involved in this relation; and f) the algebraic model is induced to generate one or more governing relations between parameters that govern the system using only measured data of the system. The algebraic model used in the method according to the invention is also identified as the Approximate Buchberger-Moeller algorithm, which computes a substantially or approximately vanishing ideal of a finite set of points and which remains numerically stable if the points are imprecise measured data.

### BACKGROUND OF THE INVENTION

The invention relates to a method for describing a system on the basis of an algebraic model of the system.

For monitoring, prediction, optimisation, and control of physical and/or other systems, a model, that generates in general terms mathematical descriptions of the behaviour of the system, is a key element. In all methods known to date in one way or the other a model structure is imposed upon the system. This model structure has usually some degrees of freedom, in general one or more ‘unknown parameters’, and this freedom is used to tune the model with respect to data available of the system. The ‘data’ are usually measurements of quantities associated with the system under consideration, like pressures, temperatures, production rates, etc.

It is generally possible with the existing methods to find a model, even when the collected data are of bad quality. This is what is called here the ‘curse of least squares’, assuming that a quadratic criterion is used to assess the goodness of fit of the model against the available data. The reason for this suggestive formulation is that what is modelled is the user's perception of how the system works. But in many systems the true physical state of the system is not reachable. That is it is not possible to establish the true conditions under which a certain physical phenomena evolves. And it is a physical law that the laws of physics are condition dependent, in other words there does not exist something like a universal law of physics for any physical phenomenon. An oil reservoir is a dramatic example of a physical system of which the true physical state is not reachable. And, in view of the scarce data collection, even the surface part of an oil and/or gas production unit is an example of a system with unreachable physical state.

It is an object of the invention to provide an improved method for describing relations in a system on the basis of an algebraic model that avoids the a priori modelling prejudice of the existing methods.

### SUMMARY OF THE INVENTION

In accordance with the invention there is provided a method for describing one or more relations in a system on the basis of an algebraic model of the system, comprising the steps of:
a) collecting data comprising measurements of different quantities relating to the system;
b) interpreting the measurements of the different quantities as evaluations of different variables, which together comprise a polynomial ring;
c) calculating an ideal of the ring, the generators of which substantially vanish on the collected data;
d) interpreting the generators as polynomial relations between the variables of the system;
e) reformulating at least one of the polynomial relations as an algebraic model for one of the variables in terms of the other variables involved in this relation; and
f) the algebraic model is induced to generate one or more governing relations between parameters that govern the system using only measured data of the system.

In the event that the algebraic model does not generate relevant relations between parameters that govern the system this is used as an indication that there is a lack of integrity of collected data.

The algebraic model generated in step (e) may be used to provide an explicit and/or implicit model for said one of the variables in terms of the other variables in said relation.

It is observed that steps (a) to (e) of the method according to the invention have been presented by H. Poulisse et al. in a lecture titled “Algebraic Computations on Noisy Measured Data” on 21 February 2006 in Linz in the context of a special semester on Groebner bases and relational methods.

In accordance with the invention it has been surprisingly found that the algebraic model derived from these algebraic computations may be induced to generate one or more governing relations between parameters that govern the system using only measured data of the system.

The method according to the invention may be used to monitor and/or optimise the performance of an industrial system, such as a hydrocarbon production and/or processing system, in particular a hydrocarbon production well and/or cluster of such wells and more in particular a cluster of hydrocarbon production wells that are connected to one or more underground hydrocarbon containing formations.

The method according to the invention may also be used to monitor and optimise the performance of an economical, business and/or any other system.

The method is particularly useful to identify a success or failure of a field experiment for testing an oil and/or gas production well or an assembly of such wells.

The method according to the invention allows modelling of a system solely on the basis of measured data. More specifically, the input for the method according to the invention may consist only of measured data generated by the system under consideration, and so in particular a model structure is not input, but a model description is output of our method. This ‘model description’ is a set of relations among the measured quantities of the considered system. This will be further specified below. The new method really settles with the ‘curse’ mentioned above, in that no—sensible—relation will be found in case the available data is not relevant, or insufficient for describing the behaviour of the considered physical system.

These and other features, embodiments and advantages of the method according to the invention are described in the accompanying claims, abstract and the following detailed description of preferred embodiments in which reference is made to the accompanying drawings.

### BRIEF DESCRIPTION OF THE DRAWINGS

FIG. 1 is a diagram which depicts measured data of a system and an approximation from a vanishing ideal made on the basis of the method according to the invention;

FIG. 2 is a diagram that shows evaluations of generating elements;

FIG. 3 is a schematic longitudinal sectional view of an oil or gas production well, which produces oil and or gas from two oil and/or gas containing formations A and B;

FIG. 4 is a plot that shows an application of the method according to the invention on the system shown in FIG. 3;

FIG. 5 shows the inflow interactions calculated with the method according to the invention; and

FIG. 6 shows the contribution of the well sections traversing the formations A and B to the total production of the well shown in FIG. 3.

### DETAILED DESCRIPTION OF PREFERRED EMBODIMENTS OF THE METHOD ACCORDING TO THE INVENTION

Suppose a physical system is considered, and that measurements of n different quantities are available.

These measurements are considered as evaluations of n different variables.

These variables comprise a polynomial ring.

The goal is to find relations among the variables.

The solution of such a relation in one of the variables involved in this relation gives a model for this variable in terms of the other variables involved in that relation. Depending on the complexity of the P= [symbol] [x₁, . . . , xₙ] is the polynomial ring over the field [symbol] of real numbers relation, this model can be an explicit, or an implicit representation. More specifically, suppose the values—evaluations—of the considered variable are measurements of the production of a well then the method gives a model for the production in terms of other variables of the considered system. But it is a model constructed by the system itself. In another perspective, because there is no a priori model, there is no ‘fitting’ of any kind involved in this method. Here are the details:

The [symbol] linear map eval: P→ [symbol] defined by eval(f)=(f(p₁), . . . , (pₙ)) is called the evaluation map associated with [symbol] so in particular eval(xₓₖ)=(p₁, . . . , pₙ) are for instance pressure measurements The ideal [symbol] =ker(eval)={f ∈P|eval(f)=0} is called the vanishing ideal of [symbol] Given a real ε>0an ideal J⊂P is called an εapproximate vanishing ideal of [symbol] if there exists a system a generators G of J such that ∥eval(g)∥=ε∥g∥ for

all g ∈ G, where ∥g∥ denotes the Euclidean norm of the coefficient vecor of g

The approximate vanishing ideal is a new concept that is introduced in accordance with the invention, and which is the key element of the method according to the invention.

Dealing with real applications generally involves dealing with uncertainty. In this connection it is not sensible to look for polynomials that vanish exactly on the available data set. This explains the introduction of the approximate vanishing ideal. The approximate vanishing condition is not preserved by multiplication by polynomials; this is the reason why the approximate vanishing is defined in terms of the generators of the ideal.

An underlying concept of the method according to the invention is to construct the system of generators for the vanishing ideal. These generators are polynomials in the considered variables, which are almost vanishing over the set of measurement points. In other words, the generators are the sought relations between the variables of the considered system.

The role of the—small—parameter epsilon in the definition of the approximate vanishing ideal in this modelling context is that different values of this parameter means finding relations on different level of complexity. In other words this parameter allows the to zoom into the system on different scales: for relatively larger values of epsilon the system is considered on a level corresponding with the end result of interactions present in the system, whereas for relatively smaller values of epsilon it is considered on a level where these interactions themselves are represented.

A suitable algorithm to compute a kernel or vanishing ideal is known in the literature as the Buchberger-Möller algorithm, which is described in the paper “The construction of multivariate polynomials with preassigned zeros” presented by B. Buchberger and H. M. Möller in the Proceedings of Eurocam 1982, Lect. Notes in Comp. Science issue 144, published by Springer, Heidelberg 1982, 24-31.

In the following Examples application of the Buchberger-Moeller algorithm is presented for computing the generators of the approximate vanishing ideal, which is hereinafter also identified as the Approximate Buchberger-Möller algorithm.

### Example 1

Considered is a well system, consisting of a multi-zone well, with production—and transportation tubing, and connected to a test separator. One of the zones,

### Indeterminate:

x₁: (DHP_{C}_{ₒₙ}-DHPₜᵤ)
x₂: G
x₃: THP
x₄: DHP_{C}_{ₒₙ}
x₅: FLP
x₆: (THP-FLP)
x₇: DHP_{E}_{ₒₙ}
x₈: DHPₜᵤ
   called zone C is tested. The other zones are closed in during the test experiment.

### Meaning of Variables:

DHP_{C}_{ₒₙ}: Annulus Pressure Zone C

DHPₜᵤ: Tubing Pressure Well System

G: Gas Production

THP: Tubing Mead Pressure Well System

FLP: Flow Line Pressure Well System

DHP_{E}_{ₒₙ}: Annulus Pressure neighbouring Zone; closed in during experiment

Q: Gross Production

### Generators of Approximate Vanishing Ideal:

$$𝒢 ( 1 ) = {x}_{9} + 0.25157 {x}_{2} - 0.90263 {x}_{1} - 0.19081$$

$$𝒢 ( 2 ) = {x}_{8} - 0.010398 {x}_{2} + 0.41332 {x}_{1} - 1.2683$$

$$𝒢 ( 3 ) = {x}_{7} - 0.0093789 {x}_{2} - 0.024008 {x}_{1} - 0.96643$$

$$𝒢 ( 4 ) = {x}_{6} + 0.032753 {x}_{2} + 2.2146 {x}_{1} - 2.4877$$

$$𝒢 ( 5 ) = {x}_{5} - 0.0086355 {x}_{2} - 0.14196 {x}_{1} - 0.84157$$

$$𝒢 ( 6 ) = {x}_{4} - 0.0094893 {x}_{2} + 0.25098 {x}_{1} - 1.16$$

$$𝒢 ( 7 ) = {x}_{3} + 0.012978 {x}_{2} + 1.1103 {x}_{1} - 1.7422$$

$$𝒢 ( 8 ) = {x}_{2}^{2} - 1.3636 {x}_{2} - 0.088155 {x}_{1} + 0.52262$$

$$𝒢 ( 9 ) = {x}_{1} {x}_{2} - 0.72789 {x}_{2} - 0.81167 {x}_{1} + 0.58504$$

$$𝒢 ( 10 ) = {x}_{1}^{2} - 0.01804 {x}_{2} - 1.6133 {x}_{1} + 0.64836$$

$$eval ( 𝒢 ( 1 ) ) \approx 0 ⇒ {x}_{9} \approx - 0.25157 {x}_{2} + 0.90263 {x}_{1} + 0.19081$$

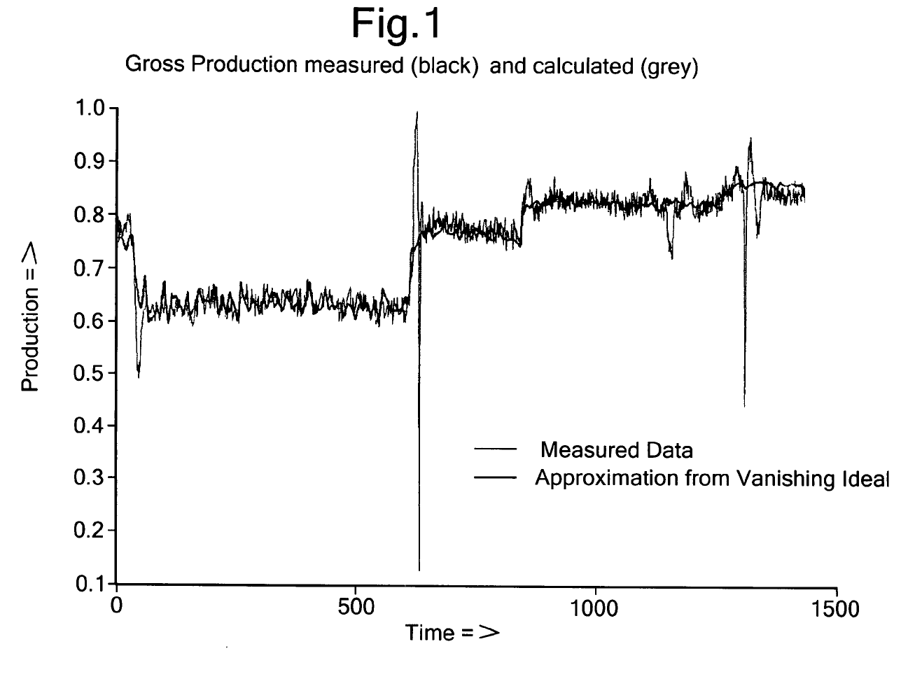

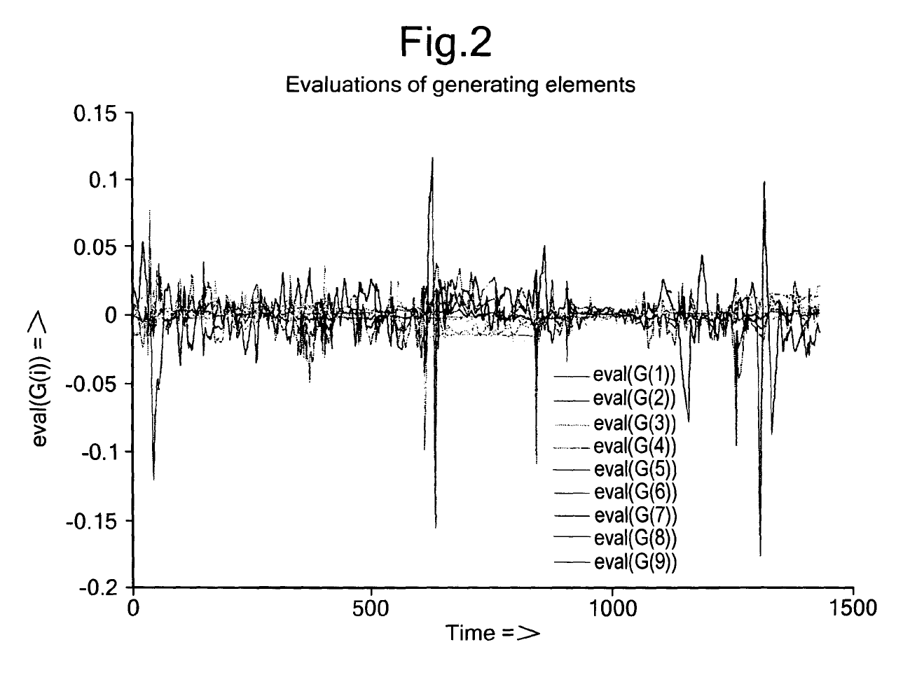

The first element of the set of generators for the vanishing ideal contains the ‘production variable’. The resulting model for the gross production is in this case, for the epsilon that has been chosen a simple linear model. The calculated production, depicted in FIG. 1 is obtained by substituting the values for the variables in the right hand side of the model equation.

Note also that the other elements of the set of generators give other relations between the variables involved in this problem. These relations are the physical relations governing the behaviour of the well system when observed on a level of complexity controlled by the parameter epsilon. These relations are generated by the method according to the invention.

### Example 2

Let [symbol] ={p₁, . . . , pₛ}⊂[−1, 1]ⁿ⊂ [symbol] let P= [symbol] x₁, . . . , xₙ]. let eval: P→ [symbol] be the associated evaluation map eval(f)=(f(p₁), . . . , f(pₛ)), and let ε>ε′>0 be small positive numbers. Moreover, we choose a degree compatible tern ordering σ. Consider the following of instructions.
A1 Start with lists G=θ, O=[1]. a matrix M=(1, . . . , 1)^{tr} ∈ Mat_{x,1} [symbol] and d=0
A2 Increase d by one and let L=[t₁, . . . , tᵣ] be the list of all terms of degree d which are not contained in <LT_{σ}(g)|g ∈ G>, ordered decreasingly w.r.t σ. If L=θ, return the pain (G, O) and stop.
A3 Let m be the number of columns of M. Form the matrix

A=(eval(t₁), . . . , eval(t₁₎,M) ∈ Mat_{sε+m} [symbol]
Using the SVD, calculate a matrix B who column vectors are on ONB of the approximate kernel apker(A,ε).
A4 Reduce B=(bᵢⱼ) to column echelon form. Normalize each column after every reduction step. If at some point a row contains no pivot element of absolute value>ε′ in the untreated columns, replace the corresponding elements of absolute value≦ε′ by zeros and continue with the next row. The result is a matrix C=(cᵢⱼ) ∈ Mat_{1+m,k} [symbol] such that cᵢⱼ=0 for i<v(j) and cₚ₍ⱼ₎ⱼ=1.
A5 For all i ∈ {1, . . . , l} such that there exists a j ∈ {1, . . . , k} with v(j)=8 (i.e. for the row indices of the pivot elements), append the polynomial

$${c}_{ij} {t}_{i} + {\sum }_{{i}^{′} = i + 1}^{l} {c}_{{i}^{′} j} {t}_{{i}^{′}} + {\sum }_{{i}^{′} = l + 1}^{l + m} {c}_{{i}^{′} j} {u}_{{i}^{′}}$$

to the list G, where u_{2′} is the (i′-l)^{the} element of O.
A6 For all i=l,l_31 1, . . . , 1 such that the i^{the} row of C contains no pivot element, append the term t, as a new first element of O, append the column eval(t₂) as a new first column to M, and continue with step A2.

This is an algorithm which computes a pair (G, O). The list F is a unitary minimal σ-Gröbner basis of the ideal 1=(G) ⊂ P and satisfies ∥eval(g)∥<δ for δ=ε\sqrt{#G}+ε′8\sqrt{8} and all g ∈ G. Moreover, we have dim_{K}(P/I)≦8.

The list O contains an order ideal of monomials whose residue classes form on [symbol] -vector space basis of P/I.

It is observed that the scaling of the points to the interval [−1,1] is not necessary for the correctness of the algorithm.

It is observed that the known Buchberger-Moeller algorithm is a well-known tool for computing the vanishing ideal of a finite set of points, but that if the coordinates of the points are imprecise measured data, the resulting Groebner basis is numerically unstable.

In accordance with the invention an improved Approximate Buchberger-Moeller algorithm is provided, which computates a substantially vanished ideal instead of a vanished ideal of a finite set of points, which algorithm remains stable if the coordinates of the points are imprecise data.

### Example 3

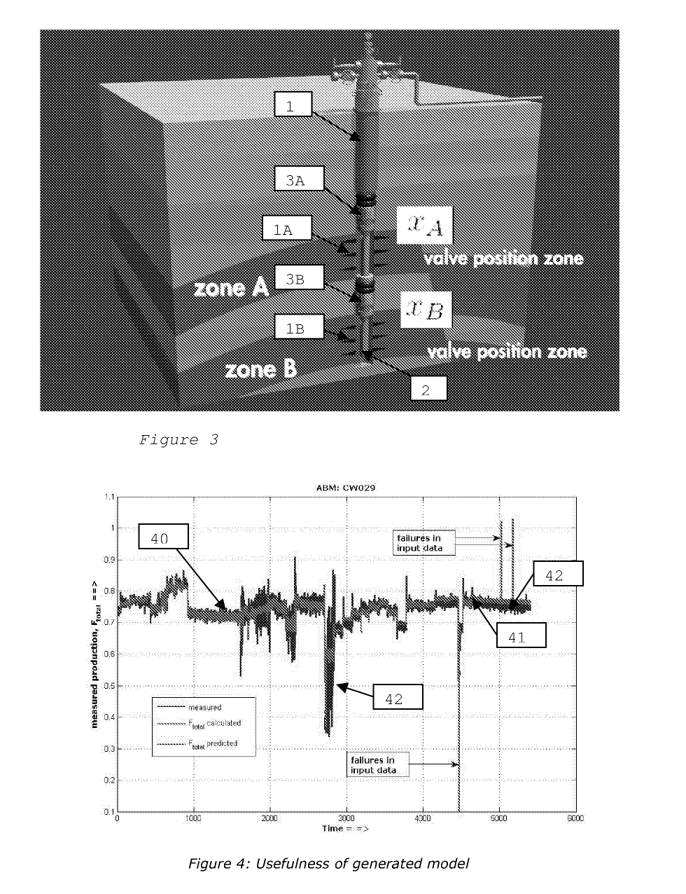

A two-zone well is considered in this example. A schematic picture is given in FIG. 3.

FIG. 3 depicts a well 1 that traverses two oil and/or gas containing formations A and B. Crude oil and/or gas flows from the formations A and B into inflow regions of the well 1, where the well casing and/or surrounding formation is perforated such that crude oil and/or gas flows from the formations A and B into annular spaces 1A and IB surrounding a production tubing 2. Inflow control valves 3A and 3B are arranged above the annular spaces 1A and 1B, which inflow control valves control the influx of crude oil and/or gas from the formations A and B into the production tubing 2.

From production operations experience it is known that the two zones interact with one another, that is influence each other's production. These interactions had been established purely experimentally, that is by observing changes in production depending on different operating conditions, in particular valve positions. However the mechanisms behind these interactions were unknown. There are also no experimental possibilities to investigate these interactions. Specifically it was not known what the contributions were to the total production with the two zones producing, and also not how this would change under changing operating conditions.

The method according to the invention has been applied to this problem. It follows that the interpretation of the model describing the—gross—production of this two-zone well generated by this algorithm provides a detailed description of the interaction mechanisms of this production system. In the following a systematic description will be presented how this analysis has been performed for this well system.

An overview of “measured variables” is provided below.

First an overview will be presented of the information in terms of measured quantities, also called variables, which is available.

Each of the zones A and B has a down-hole valve 3A and 3B, which is a valve positioned at the inflow opening of the zone into the production tubing 2. The down-hole valves 3A and 3B allow a gradual opening between fully closed—valve position zero—and fully opened—valve position. These variables are called the “valve positions of the respective zones A and B”.

Pressures are measured at the upstream side of both valves, called the “annulus pressures of the respective zones”.

Moreover pressures are measured inside the production tubing 2, so downstream from the down-hole valves 3A and 3B, called the “tubing pressures of the respective zones”.

The well system has been connected to a separator, where separation takes place between the liquid—and the gas phase. Also the pressure measured in the transportation tubing connecting the well to the separator is measured, and called the “flow line pressure”.

In the separator the liquid production—gross production—is measured, and this variable is simply called here the “production”.

Of course also the gas production is measured, but in this example the analysis concentrates on the liquid production, and therefore the gas production itself is not considered here as a variable. On the other hand it is well known that the liquid—and gas do influence one another, and so the variable that is a measure for the gas production is included in this analysis. The gas production is measured using a so-called dP-cel, and the measurement obtained with this measurement device, which is physically directly a pressure difference is the variable included in this analysis and called dP_cel.

Preliminary considerations are provided below.

Now clearly the driving forces in this sort of flow problems are pressure differences. These driving forces will determine the behaviour of the well system under consideration. In the well system considered here, several relevant driving forces may be identified.

There are first of all the driving forces at the inflow openings of the zones, in other words the driving forces over the down-hole valves. These driving forces hence determined by the pressure difference between the annulus pressure and the tubing pressure at the two zones.

Then there is the driving force related to the flow of the fluids in the production tubing; this driving force is determined by the pressure difference between the tubing pressure of zone B and that of zone A.

Obviously there is also the driving force for transporting the fluids from the well down-stream to the separator. The difference between the pressure measured at the highest location of the well, with reference to FIG. 1 which indicates that zone A is the highest zone this is the tubing pressure of zone A and the flow line pressure determines this transportation driving force.

As indicated above the quantity related to the gas production is already directly available as a pressure difference.

Rather than using the measured pressures the pressure differences as described above have been used as inputs for the algorithm. The other variables used as inputs for the algorithm are the valve positions, and the production. The idea is to find a relation, a model between the production and the other variables.

The overview below summarizes the variables as they have been used as inputs for the algorithm.

Note the use of the indicator functions. This may be viewed as a priori knowledge: only when the pressure differences have physical meaning for the flow problem under consideration they are taken on board. In other words when the valve is closed, and hence there is no flow over the down hole valve, there is also no driving force, although the measured pressure difference may very well be different from zero.

x_{A}: valve position zone A

x_{B}: valve position zone B

(ΔP)^{inf low}=(P_{B}^{annulus}−P_{b}^{tubing}).ind_{B}: driving force over down-hole valve at zone B

(ΔP)_{A}^{inf low}=(P_{A}^{annulus}−P_{A}^{tubing}).ind_{A}: driving force over down-hole valve at zone A

dP_{cel}: pressure difference related to gas product ion

(ΔP)^{production}=(P_{B}^{tubing}−P_{A}^{tubing}).ind_{B}: driving force production tubing

(ΔP)^{transportation}=(P_{A}^{tubing}−P^{flowline}): driving force transportation tubing

Q: measured liquid production

xᵢ=0 [symbol] indᵢ=0;xᵢ>0 [symbol] indᵢ=1(i=A,B)

### Results

Processing measured values of the variables specified above with the algorithm, the following model structure has been obtained for the production of the two-zone well:

Fₜₒₜₐₗ=x_{A}F_{zone}_{_{A}}+x_{B}F_{zone}_{_{B}}+x_{A}x_{B}F_{interactions}

Here Fₜₒₜₐₗ represents the production of the well system according to the model generated by the algorithm; the symbol Q is used to denote the measured production. F_{zone}_{_{A}},F_{zone}_{_{B}},F_{interactions} are polynomials in the variables specified in the above overview. Before revealing their structure first their interpretation as follows from the above equation is discussed.

Now if the down-hole valve located at zone A is closed, that is x_{A}=0 no fluids can enter the production tubing at the inflow opening located at zone A. But this means that the interpretation of F_{zone}_{_{A}} in the above

equation is the contribution to the total production that passes the down-hole valve at zone A. The importance of this formulation is that it does not imply that the fluids passing the down-hole valve at zone A are also really originating from that zone! Indeed, it may very well be that the fluids originally came from zone B.

Of course the same interpretation applies to F_{zone}_{_{B}} in the above equation for the production of this well system.

Concentrating on the third term in the above equation, it follows that only if x_{A}x_{B}>0 then this term contributes to the production of the well system. In other words this term contributes if both valves are not closed, that is if the fluids from passing the two valves have the opportunity to ‘see’ each other, i.e. to interact with one another. It follows that the interpretation, which may be associated with the third term in the above equation is that it represents the interactions taking place in the production tubing of the well system.

So what has been obtained thus far is that the production for the two-zone well may be composed in two inflow parts, and an interactions part. Before concentrating on the specifics, it is first checked whether the generated model represents the production in a useful way. This is shown in FIG. 4.

In FIG.4 CW029 is the name of the two-zone well, which is considered here. Note that the data has been scaled—between 0 and 1. This is done through a straightforward linear scaling; it is not a prerequisite for the algorithm. The scaling is performed out of confidentiality considerations. An advantage is that it does make the interpretation somewhat easier. All results can be transformed back to their original range by applying the ‘reverse’ linear scaling.

The first 4000 data points for the pressure, valve position, and production measurements have been used to generate the model for the production. The grey plot 40 gives the reconstructed production using the generated model. The last data points, from 4001 onwards have been used to predict the production by processing the pressure, and valve position measurements with the generated model—this is the grey plot 41 in FIG. 4—and comparing this with the measured production—the dark plot 42 in FIG. 4.

Now attention is given to the structure of the different parts of the production model generated by the algorithm.

F_{zone}_{_{A}}=−17.68ΔP_{B}^{inf low}ΔP^{transport}+16.34ΔP_{B}^{inf low}+11.30ΔP_{A}^{inf low}ΔP^{transport}−4.39ΔP_{A}^{inf low}+2.60dP_{cel}ΔP^{transport}−1.83dP_{cel}−4.76ΔP^{production}ΔP^{transport}+3.18ΔP^{production}+22.48(ΔP^{transport})²−33.27ΔP^{transport}+12.10

F_{zone}_{_{B}}=9.64ΔP_{B}^{inf low}ΔP^{transport}−7.35ΔP_{B}^{inf low}+0.69ΔP_{A}^{inf low}ΔP^{transport}−0.38ΔP_{A}^{inf low}+12.94dP_{cel}ΔP^{transport}−11.19dP_{cel}+5.36ΔP^{production}ΔP^{transport}−4.72ΔP^{production}+37.88(ΔP^{transport})²−72.71ΔP^{transport}−0.47x_{B}+35.73

F_{interactions}=−3.39ΔP_{B}^{inf low}ΔP^{transport}+2.04ΔP_{B}^{inf low}+33.50ΔP_{A}^{inf low}ΔP^{transport}−36.32ΔP_{A}^{inf low}−12.50dP_{cel}ΔP^{transport}+10.55dP_{cel}−14.29ΔP^{production}ΔP^{transport}+13.82ΔP^{production}−40.74(ΔP^{transport})²4.52x_{A}x_{B}ΔP^{transport}+71.49ΔP^{transport}−0.15x_{B}−4.20x_{A}x_{B}−0.25x_{A}−30.94

First of all because as mentioned above the data have been scaled, the values of the coefficients are on this level of consideration not important, but the signs of the coefficients very much so.

The terms have been grouped in the equations in such a way that the combination of two consecutive terms represents a kind of flow law. For instance consider the first two terms in the equation F_{zone}_{_{A}}: they represent a kind of flow law for the flow over the down hole valve, in the presence of downstream backpressure—ΔP^{transport}. It is however a flow law associated with zone B. This means that the inflow over the valve opening at zone A is directly influenced by zone B, and moreover the terms give directly an equation describing explicitly this interaction.

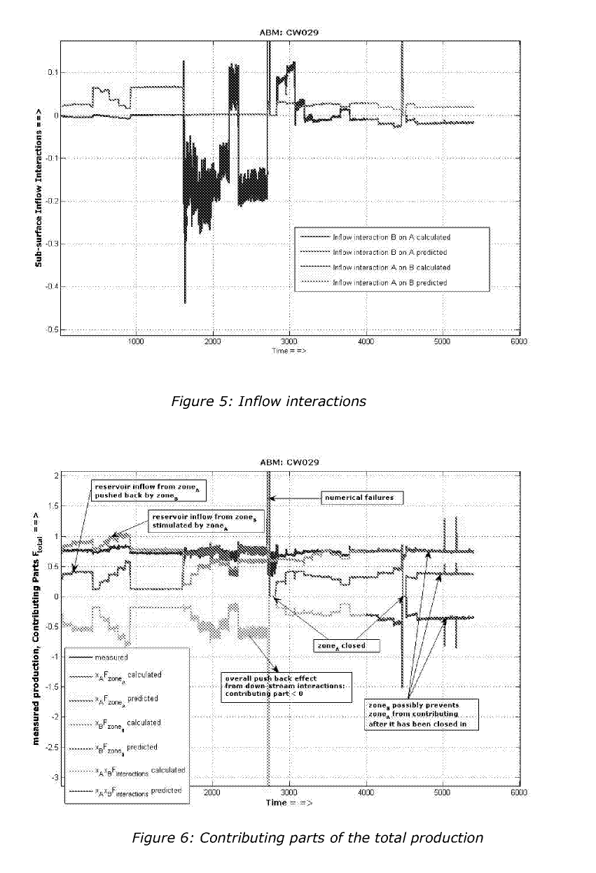

Note that similar considerations hold for the third and the fourth term appearing in the equation for F_{zone}_{_{B}}, but now with the roles of A and B reversed. Similar, but not quite the same: observe that the sign which can be associated with the flow law related to zone A appearing in the production contribution term associated with zone B is opposite to the sign with can be associated with the flow law related to zone B appearing in the production contribution term associated with zone A. So apparently there is in this respect asymmetry in the production system. This means that sometimes a zone is stimulating the other zone in terms of inflow performance from the reservoir, sometimes a zone is pushing back the inflow at the inflow opening located at the other zone. Again because the generated model gives explicit descriptions of how these inflow interactions work as a function of the production variables, this effect can be calculated. FIG. 5 below depicts the values of the flow law related to zone B in the contribution to the production associated with zone A—the first plus the second term in the equation for F_{zone}_{_{A}}—and likewise ‘the other way around—the third plus the fourth term in the equation for F_{zone}_{_{B}}.

With reference to FIG. 5, a negative value means pushing back, and a positive value means stimulation. It can be read off from FIG. 5 that in general zone A stimulates zone B, but that under certain production circumstances zone B stimulates zone A, and under different production circumstances pushes back zone A. Of course the production circumstances referred to here are captured by the measured values of the variables associated with that problem, and can in this way be identified. It is beyond the scope of this description to enter this level of detail.

In the same way the combination of two consecutive terms containing dP_{cel} are related to gas flow laws. Note again in this respect the difference in signs for these laws as part of the zone contributions with respect to the interactions contribution. The interpretation is that for the inflow performance the produced gas stimulates the liquid production, but there is a push back effect in the interactions part. This means that the higher zone produces most gas. For there is clearly no, or in any case no dominating lift gas effect, which would be the case when the deepest zone is producing most gas.

It is observed that the products between in particular the pressure differences over the down-hole valves and the pressure difference over the transportation tubing constitute a direct connection between the sub-surface and the surface.

It will be understood that the generated model provides crucial information about the working of the production system, despite the fact that there are no experimental possibilities to inspect this system directly. The production technologists have confirmed the results described above, although their confirmation is necessarily of an experimental character.

It is also clear from the description that both the structure of the generated model, and the values of the different parts constituting the generated model are used in the analysis of the production system.

This analysis is finalized by presenting plots for the three different parts of the equation for the production of the two-zone well. This is shown in FIG. 6.

It is observed that the different parts may not be interpreted separately as productions. Inspecting the interactions part, which is for the considered system always negative, substantiates this. But it does mean that overall the interactions in the production tubing have a push back effect on the production.

A last striking example of how detailed the information is that is presented by the generated model is the following: with reference to FIG. 6 note that the valve of zone A has been closed two times, while the valve of zone B remains open all the time. Now add the interactions contribution to the contribution associated with zone A over the last part of the experiment shown in FIG. 6 after the valve of zone A has been closed for the second time. The result is zero. Interpretation: zone B pushes back zone A and prevents is from contributing to the production.

It will be understood that the generated model provides crucial information for exploiting the two-zone well. For instance the last example discussed above shows that zone B has to be beaned back before the valve for zone A is opened again. The detailed expressions in the generated model give moreover recipes how to do this quantitatively. This information cannot be obtained in any other way. It contains many counter intuitive elements—like the asymmetry—and so cannot be ‘guessed’, even not by an educated guess of a production technologist.

1-11. (canceled)

12. A method for describing one or more relations in a system on the basis of an algebraic model of the system, comprising the steps of:
a) collecting data comprising measurements of different quantities relating to the system;
b) interpreting the measurements of the different quantities as evaluations of different variables, which together comprise a polynomial ring;
c) calculating an ideal of the ring, the generators of which substantially vanish on the collected data;
d) interpreting the generators as polynomial relations between the variables of the system;
e) reformulating at least one of the polynomial relations as an algebraic model for one of the variables in terms of the other variables involved in this relation; and
f) attempting to induce the algebraic model to generate one or more governing relations between parameters that govern the system using only measured data of the system.

13. The method of claim 12 wherein the system is an industrial system, further including the step of optimizing the performance of said system using the relations generated in step f).

14. The method of claim 12, further including the step of determining that the algebraic model will not generate in step f) relevant relations between parameters that govern the system and concluding that there is a lack of integrity of collected data.

15. The method according to claim 12, wherein the algebraic model generated in step e) provides an explicit or implicit model for said one of the variables in terms of the other variables in said relation.

16. The method of claim 12, wherein the system is a hydrocarbon production or processing system.

17. The method of claim 16, wherein the system is a hydrocarbon production well or cluster of such wells.

18. The method of claim 17, wherein the system is a cluster of hydrocarbon production wells connected to one or more underground hydrocarbon containing formations.

19. The method of claim 12, wherein the system is a hydrocarbon refining or hydrocarbon chemical conversion system.

20. The method of claim 12, wherein the system is an economical system.

21. The method of claim 12, wherein the system is a business system.

22. The method of claims 13, further including the step of using the method to identify a success or failure of a field experiment for testing an oil and/or gas production well or an assembly of such wells.

23. The method of claim 22, wherein the measurements of a first quantity are replaced by the measurements of other quantities by using in place of the measurements of the first quantity the model derived from the polynomial relations generated in step d)
